(19) United States
(12) Patent Application Publication
(10) Pub. No.: US 2013/0025874 A1
(43) Pub. Date: Jan. 31, 2013

(54) SYSTEM AND METHOD FOR SAMPLING MULTIPHASE FLUID AT A PRODUCTION WELLSITE

(71) Applicants: Robert Saunders, Pasadena, TX (US); John Nighswander, Katy, TX (US); Bernard THERON, Aberdeenshire (GB); Andrew Gilbert, Aberdeen (GB)

(72) Inventors: Robert Saunders, Pasadena, TX (US); John Nighswander, Katy, TX (US); Bernard THERON, Aberdeenshire (GB); Andrew Gilbert, Aberdeen (GB)

(21) Appl. No.: 13/194,931

(22) Filed: Jul. 30, 2011

(51) Int. Cl. E21B 43/36; B01D 17/038; B04C 7/00

(52) U.S. Cl. 166/357; 210/512.1; 210/196

(57) ABSTRACT

Techniques for separating downhole fluid from a wellbore penetrating a subterranean formation are provided. These techniques may involve a cyclone separator having a housing with an intake for receiving the downhole fluid and at least one outlet, a cyclone section for rotating the downhole fluid, and an isolation plate positioned below the cyclone section. The isolation plate has a plurality of slots along a perimeter thereof positionable adjacent an inner surface of the housing for selectively passing portions of the downhole fluid out of the cyclone section. The cyclone separator further having a catching section for receiving the portions of the downhole fluid passing through the isolation plate for gravitational separation into a plurality of phases therein. The catching section has a plurality of baffles for stopping rotation of the portions of the downhole fluid.

### TECHNICAL FIELD

The present invention relates generally to techniques for performing wellsite operations. More specifically, the present invention relates to techniques for sampling fluid at a production wellsite.

### BACKGROUND

Oil rigs are positioned at wellsites for performing a variety of oilfield operations, such as drilling a wellbore, performing downhole testing and producing located hydrocarbons. Downhole drilling tools are advanced into the earth from a surface rig to form a wellbore. Drilling muds are often pumped into the wellbore as the drilling tool advances into the earth. The drilling muds may be used, for example, to remove cuttings, to cool a drill bit at the end of the drilling tool and/or to provide a protective lining along a wall of the wellbore. During or after drilling, a tubular may be cemented into place to line at least a portion of the wellbore. Once the wellbore is formed, production tools may be positioned about the wellbore to draw fluid to the surface.

During wellsite operations, it may be desirable to obtain downhole fluid samples to determine various parameters of the wellsite. Techniques for sampling are described, for example, in US Patent Nos. 2008/0135239, 6,467,544, 6,659,177, and 7,243,536. In some cases, the fluid may be separated during sampling as described, for example, in U.S. patent/application Nos. 7,434,694, 20080115469 and 20100059221. In some other cases, fluid may be sampled in production or subsea operations as described, for example, in US Patent/Application Nos. 2010/0058221, 2011/0005765, 2009/028836, and 6,435,279, and in PCT Application Nos. WO2010/106499, and WO2010/106500.

Despite the development of techniques for sampling, there remains a need to provide advanced techniques for sampling wellsite fluid. It is desirable that such measurements maintain the quality of the sample as it is collected and retrieved. The invention contained herein is directed at achieving these advanced techniques.

### BRIEF SUMMARY OF THE DISCLOSURE

In at least one aspect, the techniques herein relate to a cyclone separator for separating downhole fluid received from a wellbore penetrating a subterranean formation. The cyclone separator has a housing having an intake for receiving the downhole fluid and at least one outlet, a cyclone section for rotating the downhole fluid, and an isolation plate positioned below the cyclone section. The isolation plate has a plurality of slots along a perimeter thereof positionable adjacent an inner surface of the housing for selectively passing portions of the downhole fluid out of the cyclone section. The cyclone separator also has a catching section for receiving the portions of the downhole fluid passing through the isolation plate for gravitational separation into a plurality of phases therein. The catching section has a plurality of baffles for stopping rotation of the portions of the downhole fluid.

The cyclone separator may also have a plurality of phase sensors positioned about the catching section at various levels for detecting the phases of the separated downhole fluid. The intake may be tangential to a direction of rotation of the cyclone section. The outlet may be a water drain, an oil drain, a return line, and/or a purge.

In another aspect, the techniques may relate to a system for sampling a downhole fluid from a production wellsite having a wellbore penetrating a subterranean formation. The production wellsite has a subsea component with a tubular extending into the wellbore for passage of the downhole fluid therethrough. The system has a fluid circuit fluidly connectable to the tubular for selectively passing the downhole fluid therebetween. The fluid circuit has a cyclone separator for separating the downhole fluid in the fluid circuit, and at least one sample chamber for collecting at least one of the plurality of phases of the downhole fluid. The cyclone separator has a housing having an intake for receiving the downhole fluid and at least one outlet, a cyclone section for rotating the downhole fluid, and an isolation plate positioned below the cyclone section. The isolation plate has a plurality of slots along a perimeter thereof positionable adjacent an inner surface of the housing for selectively passing portions of the downhole fluid out of the cyclone section. The cyclone separator also has a catching section for receiving the portions of the downhole fluid passing through the isolation plate for gravitational separation into a plurality of phases therein. The catching section has a plurality of baffles for stopping rotation of the portions of the downhole fluid.

The system may also have an interface for fluidly connecting the fluid circuit to the tubular, a disconnect system for selectively disconnecting the sample chamber(s) from the fluid circuit, a thermal barrier, a flushing module for discharging fluid from the fluid circuit to the tubular, and/or a meter. The fluid circuit may also have a pump for selectively pumping fluid through the fluid circuit. The pump may have at least two pumping chambers. The fluid circuit may be positioned in a housing on a skid. The system may also have a remote operated vehicle deployable from a surface unit for operative interaction with the fluid circuit.

In yet another aspect, the techniques may relate to a method for sampling a downhole fluid from a production wellsite having a wellbore penetrating a subterranean formation. The production wellsite may have a subsea component with a tubular extending into the wellbore for passage of the downhole fluid therethrough. The method involves fluidly connecting a fluid circuit to the tubular, selectively passing fluid between the tubular and the fluid circuit, separating the downhole fluid into a plurality of phases with the cyclone separator, and collecting at least one of the phases in the sample chamber(s).

The method may also involve deploying at least a portion of the fluid circuit with a remote operated vehicle deployed from a surface unit, retrieving at least a portion of the fluid circuit with a remote operated vehicle deployed from a surface unit, and/or flushing at least a portion of the downhole fluid from the fluid circuit.

### BRIEF DESCRIPTION OF THE DRAWINGS

So that the above recited features and advantages of the present invention can be understood in detail, a more particular description of the invention, briefly summarized above, may be had by reference to the embodiments thereof that are illustrated in the appended drawings. It is to be noted, however, that the appended drawings illustrate only typical embodiments of this invention and are, therefore, not to be considered limiting of its scope, for the invention may admit to other equally effective embodiments. The figures are not necessarily to scale, and certain features and certain views of the figures may be shown exaggerated in scale or in schematic in the interest of clarity and conciseness.

FIG. 1 is a schematic view of a wellsite having a sampling system according to the invention.

FIG. 2 is a schematic view of various sampling systems having an interface, a separation circuit and a sample chamber.

FIG. 3A is schematic side view of a separator. FIG. 3B depicts a cross-sectional view of the separator of FIG. 3A taken along line 3B-3B.

FIG. 4 is a flow chart of a method of sampling a fluid from a wellsite.

### DETAILED DESCRIPTION

The description that follows includes exemplary apparatuses, methods, techniques, and/or instruction sequences that embody techniques of the present inventive subject matter. However, it is understood that the described embodiments may be practiced without these specific details.

Sampling of multiphase fluid from a production wellsite may be performed to determine parameters of the fluid as it is produced from the wellbore. Such sampling may involve phase enrichment, the separation of the fluid into phases (e.g., oil, water, gas, sand, etc.) and retrieval of sufficient volumes for a full range of testing (e.g., Water Liquid Ratio (WLR), Gas Volume Fraction (GVF), etc.). The techniques used herein may be adaptable to a variety of conditions, such as various wellsite configurations (e.g., various ports), various fluid conditions (e.g., temperature, pressure, etc.), and/or the presence of debris. The techniques used herein may also be performed to maintain fluid conditions (e.g., temperature, pressure, etc.), to avoid phase composition changes of the fluid, to provide continuous fluid processing, to reinject unwanted fluids back to the wellsite, to retrieve samples by constant pressure vessel(s), etc.

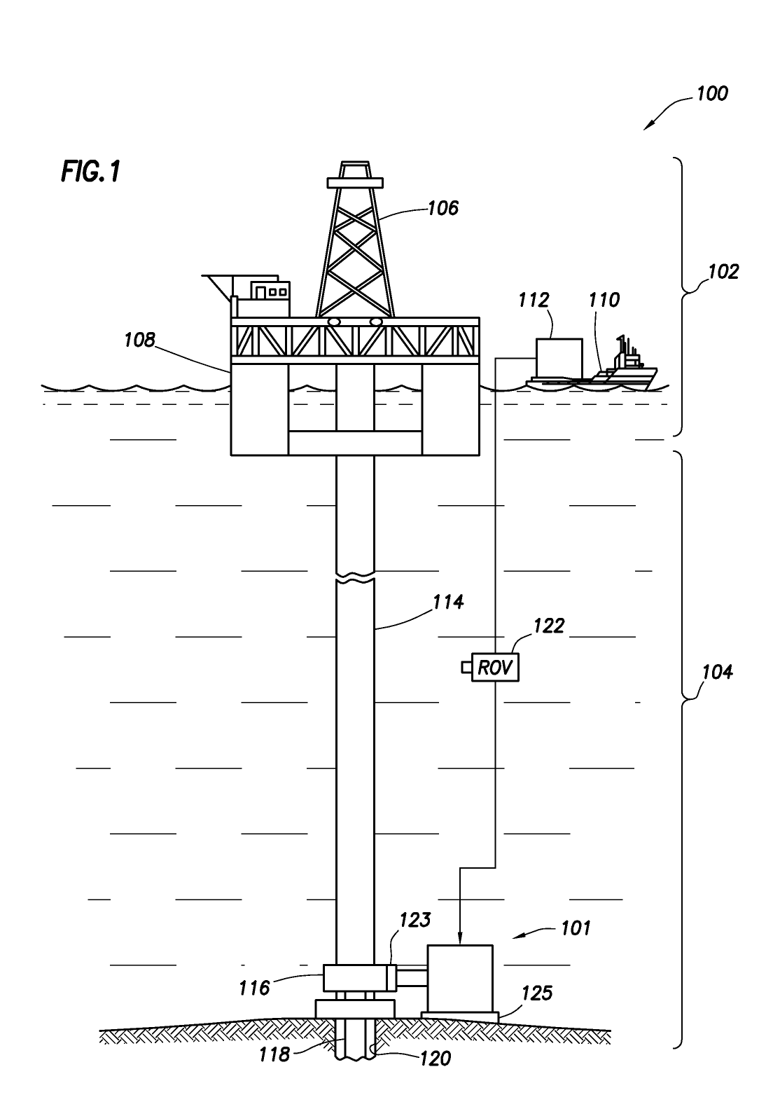

FIG. 1 depicts an offshore wellsite 100 having a sampling system 101 in accordance with the invention. The wellsite 100 has a surface system 102 and a subsea system 104. The surface system 102 includes a rig 106, a platform 108, a vessel 110 and a surface controller 112. The surface controller 112 may be provided with hardware and software for operating the surface system 102 and subsea system 104.

The subsea system 104 includes a tubing (or conduit) 114 extending from the platform 108 to a subsea unit 116, a tubular 118 extending downhole from the subsea unit 116 into a wellbore 120, the sampling system 101, and a remote operated vehicle (ROV) 122 deployable from the vessel 110 to the sampling system 101. Other subsea devices, such as a conveyance delivery system, manifold, jumper, etc. (not shown), may also be provided in the subsea system 104. While the wellsite 100 is depicted as a subsea operation, it will be appreciated that the wellsite 100 may be land or water based.

The sampling system 101 is connectable to a port 123 in the subsea unit 116 for sampling fluid flowing through tubular 118. As shown, the subsea component 116 is at the wellhead, but may be any component of the wellsite that has fluids flowing therethrough, such as the manifold, jumper or other devices (not shown). The sampling system 101 is fluidly connectable to the port 123 of the subsea component 116 for receiving fluid therefrom. Fluid may be passed between the subsea component 116 and the sampling system 101 during sampling operations as described further herein.

The sampling system 101 may be deployed to the subsea location on a skid 125. The skid 125 may be self sufficient, or deployed and/or operated by the ROV 122. In some cases, the ROV 122 and the skid 125 may be a single unit deployable to the subsea location. The ROV 122 may be linked to the vessel 110 and controlled thereby. The ROV 122 may be linked to the sampling system 101 for communication therewith. The ROV 122 may be used to provide power and/or control signals to the sampling system 101, and/or to retrieve data and/or samples from the sampling system 101. Collected samples may be taken back to the surface for analysis by the ROV 122. While the ROV 122 may be used to provide communication, power, transportation of samples and/or other capabilities, such features may be provided by other devices and/or within the sampling system 101 and the like.

To operate the surface system 102, subsea system 104 and/or other devices associated with the wellsite 100, the surface unit 112 and/or other controllers may be positioned about the wellsite and placed in communication with various components of the surface system 102 and/or subsea system 104. These controllers may be any suitable communication means, such as hydraulic lines, pneumatic lines, wiring, fiber optics, telemetry, acoustics, wireless communication, etc. The surface system 102 and/or subsea systems 104 at the wellsite 100 may be automatically, manually and/or selectively operated via one or more controllers (e.g., surface unit 112). Some such controllers may be separate units at the surface, such as surface unit 112, or at other locations, such as incorporated as part of sampling system 101.

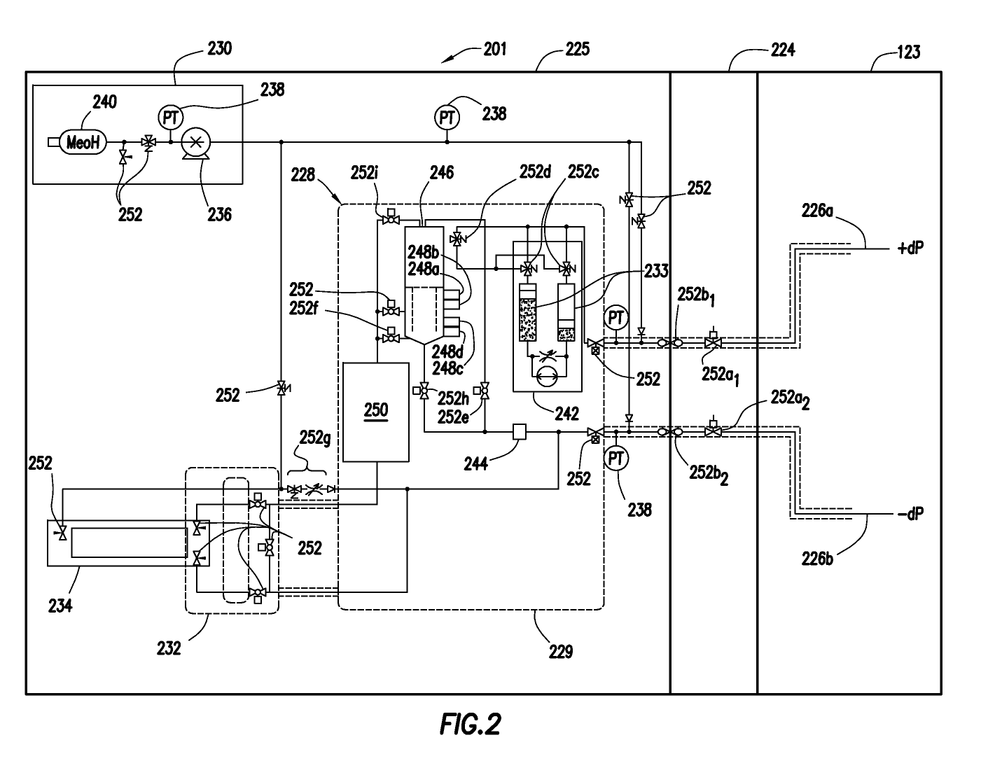

Referring to FIG. 2, a sampling system 201 usable as the sampling system 101 of FIG. 1 is depicted. The sampling system 201 includes an interface 224 operatively connectable to the port 123, and a separation circuit 225 with a sampling chamber 234 for collecting fluid. The interface 224 may be used to fluidly connect the sampling system 201 to the port 123. The sampling system 201 is fluidly connected to the port 123 by the interface 224 for drawing fluid therein. The sampling system 201 may have a separation circuit 225 for separating the fluid into samples, and collecting samples in the sample chamber 234. The sampling system 201 may be provided with various valves, flowlines, or other flow devices to manipulate flow therethrough as will be described further herein.

The sampling system 201 may be operated at certain conditions to maintain quality parameters, such as pressure and temperature of the fluid, and/or to cope with fluctuating inlet rates. For example, the sampling system 201 may be manipulated to maintain multiphase mixtures of live hydrocarbon at or near saturation pressure. At saturation pressure, decreases in pressure may result in the liberation of gas within the fluid (which may be gas or water), or the condensation of liquid within the gas phase, which may cause a deviation of the fluid composition and/or an unrepresentative sample. Liberation of gas may also amplify the mixture velocity (similar to opening a bottle containing a carbonated drink) and further inhibit separation. Variations of pressure may be inherent to systems where fluid is received at high pressure and released at low pressure. The separation circuit 225 may be used to dampen variation of speed in the intake of fluid and facilitate fluid separation, thereby minimizing phase composition change.

The sampling system 201 includes an interface 224 and a separation circuit 225. The interface 224 may be a conventional hot stab or other device for linking the separation circuit 225 to a port 123 about the subsea component 116. One or more ports 123 may provide access to the production or other fluid passing through the tubular 118, tubing 114 and/or other downhole components (FIG. 1). The port 123 may also provide access to the downhole electrical, hydraulic or other components. The interface 224 may connect and disconnect to the port(s) 123 installed at the sampling location and linked to the subsea component 116 and/or the tubular 118. The interface 224 may be used to establish fluid, hydraulic and/or electrical communication between the separation circuit 225 and the port 123. The interface 224 may provide an intake flowline 226a for drawing fluid from and an outtake flowline 226b for passing fluid into the port 123. One or more intake flowlines 226a and/or outtake flowlines 226b may be provided for manipulating fluid flow between the separation circuit 225 and the subsea component 116. In some cases, the flow may be reversed making 226a the outtake and 226b the intake. With this configuration, fluids can be sampled and/or discharged from either flowline 226a and/or flowline 226b. To selectively reverse flow, pump 242 and/or certain valves may be selectively reversed.

The flowlines 226a,b may be maintained at close pressures (for example when these flowlines are along a similar portion of the subsea component 116 or in close proximity to each other), or may have a differential pressure therebetween (for example when flowlines are located on different sides of a production choke (not shown) at the subsea component 116).

Fluid drawn into intake flowline 226a may be fluid, such as production, formation, or other fluid, passing through tubular 118 and/or tubing 114. Fluid passed through outtake flowline 226b may be fluid, such as discharge, sampled, separated, buffer, hydraulic or other fluid. In some cases, it may be desirable to selectively pump fluid into or out of the separation circuit 225 to, for example, manipulate pressure, sample selected fluid, maintain sample quality, discharge fluid, etc.

The separation circuit 225 has a variety of fluidly connected fluid components to manipulate fluid during a sampling operation. The fluid components may include a control circuit 228, a flushing module 230, a disconnect system 232, and a sample chamber 234. The control circuit 228 and the flushing module 230 are selectively fluidly connectable to the intake flowline 226a and outtake flowline 226b of interface 224. The control circuit 228 and the flushing module 230 are also selectively fluidly connected to the disconnect system 232. Sample chamber 234 is selectively fluidly connected to the control circuit 228, the flushing module 230, and the disconnect system 232. Various flowlines, valves and/or other devices may be provided to establish selective fluid communication between the various fluid components.

The flushing module 230 includes a pump 236, a pressure transmitter 238 and a charging fluid tank 240. The pump 236 may be used to increase pressure in the separation circuit 225. The pressure transmitter 238 may be used to measure pressure of the fluid. The charging fluid tank 240 may contain, for example methanol (MeOH) or other fluid, to provide pressure to the separation circuit 225. The flushing module 230 may be used to selectively pressurize the separation circuit 225 to, for example, manipulate fluid flow, measure pressure or other fluid parameters, detect leaks, etc.

The control circuit 228 includes various fluid control components, such as a pump 242, an orifice 244, a fluid separator 246, probes 248, a meter 250, and valves 252. The pump 242 is depicted as a double volume pump with two pumping chambers 233 for selectively pumping fluid through the separation circuit 225. While two pumping chambers 233 are depicted, the pump may have various numbers of pumping chambers, or be any pump capable of manipulating the flow of fluid through the separation circuit. The fluid separator 246 may be used to separate fluid into phases, such as liquid and gas, and/or into components, such as water and oil. The fluid separator 246 may be provided with electrical or optical probes (or phase detectors) 248 for detecting fluid levels in the fluid separator 246. Meter 250 may be a flow meter or other device for detecting fluid flow in the control circuit 228. Various sensors, such as probes 248, flow meter 250, or other sensors, may be positioned about the control circuit 228 for monitoring, for example, temperature, pressure, flow rate, composition, etc.

Disconnect system 232 may include valves 252 and flowlines for selectively establishing fluid communication with the flushing module 230 and/or control circuit 228. The disconnect system may provide a pressure and/or safety barrier for controlling fluid flow into or out of the sample chamber 234 and/or for maintaining pressure therein. The disconnect system 232 may selectively divert fluid into the sample chamber 234 for sampling or increasing pressure therein. For example, the disconnect system 232 may be used to selectively divert portions of separated fluid into the sample chamber 234 for collection therein. The disconnect system 232 may also selectively divert fluid out of the sample chamber to lower pressure, release sampled fluid and/or release buffer (or hydraulic) fluid. For example, the disconnect system 232 may be used to flush undesired types of separated fluid from the sample chamber 234.

Various valves 252 may be positioned about the control circuit 228 and/or the separation circuit 225 for manipulating the flow of fluid therethrough. Certain valves 252 are identified herein by reference numbers and letters, such as 252a-h, for describing operation of the systems herein. The valves 252 may be one or more isolation valves, one way valves, exit valves, needle valves, bypass, or other valves. The valves 252 may be controlled by the surface controller 112, sampling system 101, and/or self-activated, for example, upon a given condition. Other flow control devices, such as restrictors, pretesters, diverters, fluid connectors and/or other devices may be provided to manipulate fluid. Various combinations of flowlines may also be provided to establish a desired circuit for passing fluid through the sampling system 201. Features and configurations usable with the sampling systems 101 and/or 201 are described in PCT Application Nos. WO2010/106499, WO2010/106499 and WO2010/106500.

In operation, fluid may flow into the separation circuit 225 through intake flowline 226a. Fluid may be selectively diverted (directly or indirectly) into separator 246. The fluid may be pumped using pump 242 or allowed to flow using differential pressure in the flowlines. Pressure in the flowlines may be controlled by the pump 242 or other devices, such as the orifice 244. Pressure may also optionally be controlled by manipulating flow through the separator 246.

Fluid flowing into the control circuit 228 may be passed to the separator 246. Flow may be regulated during sampling based on pressures at the subsea component 116. Where no differential pressure is available, pump 242 may be activated to draw fluid into the separation circuit 225. In such cases, the flow may be generated by reciprocating the pistons of the pumping chambers 233 of the hydraulic pump 242 to avoid large pressure fluctuations in the system and, therefore, facilitate flow control. The separator 246 may then be operated with a minimum amount of flow control. The pumping sequence may be continued until a desired amount of fluid at a desired phase is collected in the separator 246.

In some cases, differential pressure across the separation circuit 225 may be sufficient to enable fluid to flow without requiring the pump 242. However, differential pressure may be so high that fluid flow may need to be controlled. Pump 242 may be used to restrain excessive flow through the separation circuit 225. Pump 242 may be provided with a hydraulic regulator to monitor fluid flow and/or pressures. Depending whether the sampling is taken at entry port pressure or exit port pressure conditions, the pump 242 may be located upstream or downstream of the separator 225.

When the pump 242 is located upstream of the separator 246, large fluctuations of pressure (inlet to exit pressure) may occur when reversing the pump 242. These fluctuations may create a speed variation at the inlet due to, for example, gas expansion. The separator 246 may be used to handle such variation. When the pump 242 is located downstream of the separator 246 (to sample at inlet pressure condition) expansion may occur after the separator.

The control circuit 228 may use the pump 242 and/or separator 246 (and other components of the separation circuit 225) to create and control sampling flowrates across the separation circuit 225. Samples may be maintained at or near line pressure and temperature during the sampling process to ensure representative samples.

Fluid entering the control circuit 228 may be directed to the fluid separator 246 for separation into phases. For example, liquid may be segregated from gas by centrifugal action of the fluid separator 246 when fluid flow rate is large enough and/or separated by gravity at lower flow rates. Fluid levels in the separator 246 may be controlled by valves and the phase detectors (optical or electric probes) 248. Multiple phase detectors 248a-d may be positioned about the separator 246 at various heights (or levels) to detect separation of fluid in the separator 246.

Fluid received by separator 246 may be used to concentrate each phase and capture enough volume of the required phases for the various flowline conditions, such as a large range of gas volume fraction (GVF), water cut, total flowrate, sand, etc. The separator 246 may be configured to separate the fluid into phases, and to control the volume of each phase therein. The separator 246 may also be configured to handle variable fluid flowrates, even at high levels, and to reduce sampling time by selectively separating desired fluid. In cases where only certain phases, such as a low concentration phase, are desired, the separator 246 may perform separation only on the desired phase(s).

In some cases, a restrictor (or orifice) 244 may be used to reduce flow rates. However, the separator 246 may be configured to handle even large variations of flow rates and to allow the use of a lower quality multiphase flow regulator. The pump 242 may optionally be used in conjunction with the separator 246, for example, in configurations with the sampling ports connected to low differential pressure and/or with multiphase mixtures.

The control circuit 228 (as well as other portions of the separation circuit 201) may also be provided with a thermal barrier 229 used to provide thermal management of the fluid. Examples of techniques for providing thermal control in a fluid circuit are depicted in WO2010/106500. Thus, the control circuit 228 may provide thermal management and pressure control of the fluid during operation. Pressure and temperature barriers, and/or actively heated sample chambers 234 may also be used to ensure that the fluid remain at the desired condition.

The various phases may be enriched by sequentially performing water, oil, gas and sand separation sequences. Phase enrichment may involve separation of fluid into, for example, oil, water and gas phases into sufficient volumes for analysis. Phase enrichment may be made at the same temperature and pressure as present in the tubular 118 to avoid phase composition changes. Phase enrichment may be a continuous process which allows reinjection of unwanted (or flushed) fluid back into the tubular 118 and/or tubing 114. Water separation may be performed by continuously directing fluid from intake flowline 226a into the fluid separator 246. Valves 252d and 252e may be opened to allow fluid to enter the fluid separator 246. During separation, water may accumulate at the bottom until the water level is detected by the phase sensors 248.

Once water is detected, valve 252e may be closed while valve 252d remains open to maintain line pressure. Water may be transferred to the sampling chamber 234 by opening valve 252f until the water level position is detected at the low position by the phase sensor(s) 248a-d. The speed of fluid transfer to the sample chamber 234 may be controlled, for example, by adjusting valve 252g. The operation can be repeated depending upon the size of the sampling chamber(s) 234 and the separator 246. The flowmeter (or densitometer) 250 may be used to check the quantity and quality of the fluid passing from the fluid separator 246 to the sample chamber 234.

Oil separation may be performed similar to the water sequence, but with additional water purge periods made by opening valve 252h to release accumulated water and or debris/sand from the fluid sample. Oil, water and/or other phase levels may be monitored by the phase sensors 248a-d. Certain valves may be provided in the fluid separator 246, for example at outlets 356b,c, to be opened from time to time to let certain phases, such as the oil phase, accumulate in a mid section of the fluid separator 246.

Gas separation may be performed by continuously directing fluid from the intake flowline 226a to the fluid separator 246 with only valve 252h in the open position. Gas may accumulate in an upper portion of the separator 246 until gas is detected by the phase sensor 248. Once detected, the gas may be transferred to the sampling chamber 234 by closing valve 252h and opening valve 252i. During this sequence, the intake flowline 226a may remain fluidly connected through valve 252i.

Sand separation may be performed as needed. Sand may be collected at the bottom of the fluid separator 246 and retrieved for sand analysis. Other sequences may be performed for other operations as desired.

Fluid may be selectively diverted for sampling, or flushed out through outtake flowline 226b. Flushing module 230 may be used to facilitate flushing of the fluid. When sampling, it may be desirable to flush a first portion of fluid passing through the separation circuit 225 before, during or after collecting a sample. Fluid to be sampled may be passed through outtake flowline 226b and back into the wellbore through port 123.

Once collected, samples may be transported back to the surface in a pressurized and/or an isothermal environment to maintain sample integrity. As desired, one or more of the phases may be collected in one or more sample chambers 234. Once a sample is collected, the sampling chamber 234 may be isolated and removed. Multiple sample chambers 234 may be positioned in the separation circuit 225 (as part of the pump 242 or separate therefrom), or a sample chamber 234 may be replaced as another one is filled. For example, the sample chambers 234 may be available either on a rack where several sample chambers are mounted with their associated valves, or as individual sample chambers 234 stored on a separate basket and connected to the separation circuit 225 by the ROV 122 (FIG. 1). Once sampling is complete, the ROV 122 may retrieve the sample chambers 234 and/or the sampling system 201 to the surface.

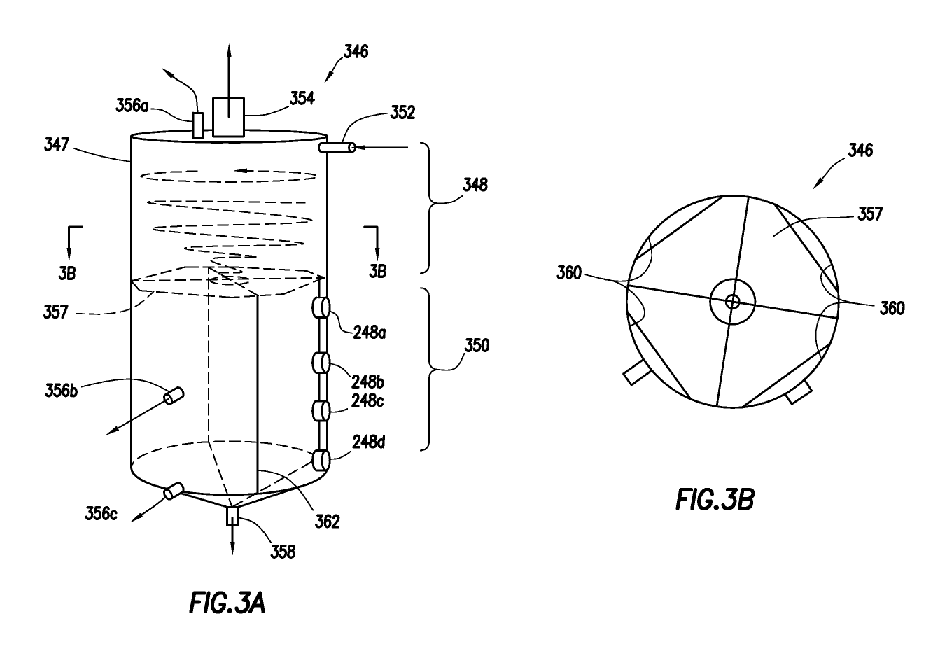

FIGS. 3A and 3B depict views of a fluid separator 346 usable as the fluid separator 246 of FIG. 2. The fluid separator 346 may be used to separate fluid in the separation circuit 225 into, for example, gas, oil, water, and sand. As depicted in FIGS. 3A and 3B, the fluid separator 346 is a cyclone separator for rotationally mixing fluid therein and separating the fluid into phases using centrifugal forces.

The fluid separator 346 includes a housing 347 having a cyclone section 348 and a catching section 350 therein. The fluid separator 346 has an intake 352 for receiving fluid from the separation circuit 228, a return line 354, drains 356a-c, and a purge 358 for releasing fluid therefrom. Fluid from return line 354 may be returned to the control circuit 228 for sampling or discharge. Fluid or debris, such as sand, from drains 356a-c and purge 358 may be diverted, for example, through the control circuit 228 and to the outtake flowline 226b.

The cyclone section 348 uses a cyclone separator to separate a multiphase fluid. The fluid may enter the separator 346 on the tangential entry through intake 352. The fluid is rotated by the cyclone section 348 to generate a spin in the fluid. Centrifugal forces generated by rotating the fluid push the heavier phases along an inner perimeter of the housing 347, while lighter phases, such as gas, may remain near a central portion of the housing 347.

An isolation plate 357 is positioned between the cyclone section 348 and the catching section 350 to facilitate separation of the fluid. The isolation plate 357 has flow slots 360 between a portion of the perimeter of the isolation plate 357 and an inner perimeter of the housing 347. The slots 360 may be positioned to allow passage of fluid from the cyclone section 348 to the catching section 350. Heavy phases of the fluid that migrate to the perimeter of the housing 347 may flow through the flow slots 360 and into the catching section 350.

The isolation plate 357 may be used to reduce the momentum of fluid spinning in the cyclone section 348. The catching section 350 is provided with anti-rotating baffles 362 to further reduce or stop fluid rotation. The catching section 350 may be a quiet zone where heavy portions of the fluid may be isolated from the spinning fluid of the cyclone section 348 for collection and segregation by gravity. Phase sensors 248a-d may be located about the catching section 350 at various levels to monitor the captured amounts of each phase.

The separator 346 may be run in sequences or continuously to collect or capture certain phases from the fluid coming in. For example, to capture water, the separator 346 may be activated until the water level reaches one of the sensors 248a-d at a desired level in the catching section 350. During this operation, fluid may be permitted to enter the separator 346 through inlet 352 and exit through the return line 354 such that only a fraction of water separated by the cyclone effect will be trapped at the bottom. To catch oil, fluid may be permitted to enter the separator 346 through inlet 352 and through the return line 354 such that only a fraction of oil separated by the cyclone effect will be trapped at the bottom. During oil separation, purge 358 and/or drain 356c may be open from time to time to remove water. Sand may be trapped along a bottom portion of the catching section 350. This sand may selectively be released through purge 358 and collected for sand content analysis.

To catch gas, fluid may be permitted to enter the separator 346 through inlet 352, while the purge 358 remains open. Some gas may accumulate at the top by gravity while the remainder of the fluid exits through the purge 358. When the gas level reach the lowest level sensor 248d, the purge 358 can be closed to stop the flow out of the separator 346 and to equalize pressure with the intake flowline 226a. The gas may be drained from drain 356a. Draining may continue until liquid is detected by the top sensor 248a. The flow out of drain 356a may be controlled to minimize remixing of fluid entering intake 352.

Fluid separated by separator 346 may be diverted to the sample chamber 234 (FIG. 2) for sampling. In some cases, the fluid may be separated and stored in the separator 346 in a given amount by controlling the levels. The separator 346 may be retrieved to the surface by, for example, the ROV 122 of FIG. 1. The separator 346 may be insulated and/or heated, for example, to provide isothermal conditions during sampling. The isothermal conditions may be extended until the return of the sample to surface.

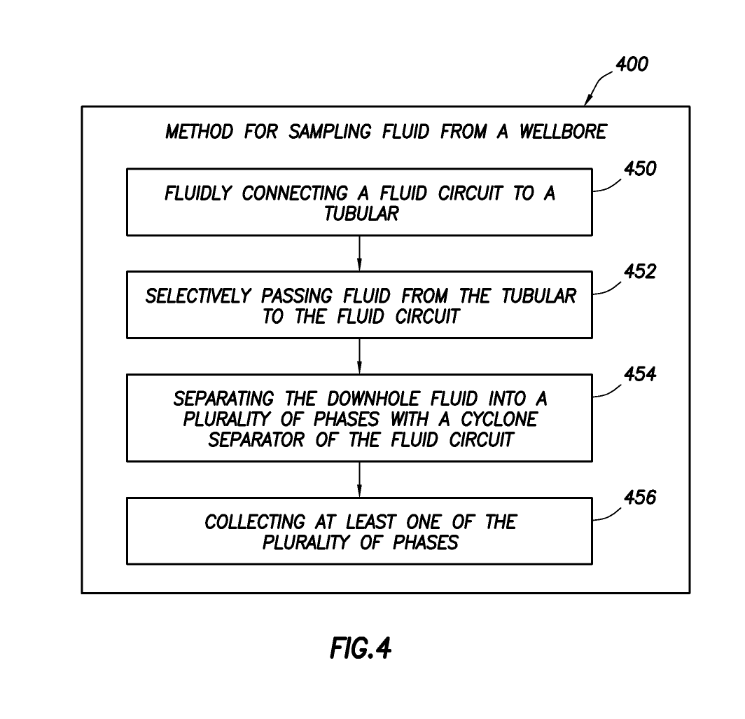

FIG. 4 depicts a method 400 for sampling fluid from a wellbore. The method 400 may involve fluidly connecting (450) a fluid circuit to the tubular, selectively passing (452) fluid from the tubular to the fluid circuit, separating (454) the downhole fluid into a plurality of phases with a cyclone separator of the fluid circuit, and collecting (456) at least one of the plurality of phases with the cyclone separator and/or in at least one sample chamber. The method may also involve deploying at least a portion of the fluid circuit with a remote operated vehicle deployed from a surface unit, retrieving at least a portion of the fluid circuit with a remote operated vehicle deployed from a surface unit, and flushing at least a portion of the downhole fluid from the fluid circuit. The steps may be performed in various orders and repeated as desired.

While the present disclosure describes specific aspects of the invention, numerous modifications and variations will become apparent to those skilled in the art after studying the disclosure, including use of equivalent functional and/or structural substitutes for elements described herein. For example, the sampling system herein may use one or more separators in various circuit arrangements to selectively separate and/or manipulate fluid flow into one or more sample chambers for sampling.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A cyclone separator for separating downhole fluid received from a wellbore penetrating a subterranean formation, comprising:
a housing having an intake for receiving the downhole fluid and at least one outlet;
a cyclone section for rotating the downhole fluid;
an isolation plate positioned below the cyclone section, the isolation plate having a plurality of slots along a perimeter thereof positionable adjacent an inner surface of the housing for selectively passing portions of the downhole fluid out of the cyclone section; and
a catching section for receiving the portions of the downhole fluid passing through the isolation plate for gravitational separation into a plurality of phases therein, the catching section having a plurality of baffles for stopping rotation of the portions of the downhole fluid.

2. The cyclone separator of claim 1, further comprising a plurality of phase sensors positioned about the catching section at various levels for detecting the plurality of phases of the separated downhole fluid.

3. The cyclone separator of claim 1, wherein the intake is tangential to a direction of rotation of the cyclone section.

4. The cyclone separator of claim 1, wherein the at least one outlet comprises a water drain.

5. The cyclone separator of claim 1, wherein the at least one outlet comprises an oil drain.

6. The cyclone separator of claim 1, wherein the at least one outlet comprises a return line.

7. The cyclone separator of claim 1, wherein the at least one outlet comprises a purge.

8. A system for sampling a downhole fluid from a production wellsite having a wellbore penetrating a subterranean formation, the production wellsite having a subsea component with a tubular extending into the wellbore for passage of the downhole fluid therethrough, the system comprising:
a fluid circuit fluidly connectable to the tubular for selectively passing the downhole fluid therebetween, the fluid circuit comprising:
a cyclone separator for separating the downhole fluid in the fluid circuit, the cyclone separator comprising:
a housing having an inlet for receiving the downhole fluid and at least one outlet;
a cyclone section for rotating the downhole fluid;
an isolation plate positioned below the cyclone section, the isolation plate having a plurality of slots along a perimeter thereof positionable adjacent an inner surface of the housing for selectively passing portions of the downhole fluid out of the cyclone section; and
a catching section for receiving the portions of the downhole fluid passing through the isolation plate for gravitational separation into a plurality of phases therein, the catching section having a plurality of baffles for stopping rotation of the portions of the downhole fluid; and
at least one sample chamber for collecting at least one of the plurality of phases of the downhole fluid.

9. The system of claim 8, further comprising an interface for fluidly connecting the fluid circuit to the tubular.

10. The system of claim 8, further comprising a disconnect system for selectively disconnecting the at least one sample chamber from the fluid circuit.

11. The system of claim 8, further comprising a thermal barrier.

12. The system of claim 8, further comprising a flushing module for discharging fluid from the fluid circuit to the tubular.

13. The system of claim 8, further comprising a meter.

14. The system of claim 8, wherein the fluid circuit further comprises a pump for selectively pumping fluid through the fluid circuit.

15. The system of claim 14, wherein the pump comprises at least two pumping chambers.

16. The system of claim 8, wherein the fluid circuit is positioned in a housing on a skid.

17. The system of claim 8, further comprising a remote operated vehicle deployable from a surface unit for operative interaction with the fluid circuit.

18. A method for sampling a downhole fluid from a production wellsite having a wellbore penetrating a subterranean formation, the production wellsite having a subsea component with a tubular extending into the wellbore for passage of the downhole fluid therethrough, the method comprising:
fluidly connecting a fluid circuit to the tubular, the fluid circuit comprising:
a cyclone separator for separating the downhole fluid in the fluid circuit, the cyclone separator comprising:
a housing having an inlet for receiving the downhole fluid and at least one outlet;
a cyclone section for rotating the downhole fluid;
an isolation plate positioned below the cyclone section, the isolation plate having a plurality of slots along a perimeter thereof positionable adjacent an inner surface of the housing for selectively passing portions of the downhole fluid out of the cyclone section; and
a catching section for receiving the portions of the downhole fluid passing through the isolation plate for gravitational separation into a plurality of phases therein, the catching section having a plurality of baffles for stopping rotation of the portions of the downhole fluid; and
at least one sample chamber for collecting at least one of the plurality of phases of the downhole fluid;
selectively passing fluid between the tubular and the fluid circuit;
separating the downhole fluid into the plurality of phases with the cyclone separator; and
collecting at least one of the plurality of phases in the at least one sample chamber.

19. The method of claim 18, further comprising deploying at least a portion of the fluid circuit with a remote operated vehicle deployed from a surface unit.

20. The method of claim 18, further comprising retrieving at least a portion of the fluid circuit with a remote operated vehicle deployed from a surface unit.

21. The method of claim 18, further comprising flushing at least a portion of the downhole fluid from the fluid circuit.
